(19) United States
(12) Patent Application Publication
(10) Pub. No.: US 2023/0275907 A1
(43) Pub. Date: Aug. 31, 2023

(54) GRAPH-BASED TECHNIQUES FOR SECURITY INCIDENT MATCHING

(71) Applicant: Microsoft Technology Licensing, LLC, Redmond, WA (US)

(72) Inventors: Anna Swanson BERTIGER, Seattle, WA (US); Daniel Lee MACE, Bellevue, WA (US); Andrew White WICKER, Snoqualmie, WA (US)

(21) Appl. No.: 17/683,257

(22) Filed: Feb. 28, 2022

(51) Int. Cl. H04L 9/40; G06F 16/901

(52) U.S. Cl. CPC H04L 63/1416; H04L 63/1425; H04L 63/1441; G06F 16/9024

(57) ABSTRACT

In network security systems, graph-based techniques can be used to identify, for any given security incident including a collection of security events, other incidents that are similar. In example embodiments, similarity is determined based on graph representations of the incidents in which security events are represented as nodes, using graph matching techniques or incident thumbprints computed from node embeddings. The identified similar incidents can provide context to inform threat assessment and the selection of appropriate mitigating actions.

### BACKGROUND

Commercial enterprises and other organizations that operate large computer networks typically employ a number of hardware- or software-based network security tools to monitor network communications and guard against cybersecurity threats. These network security tools, which may include, e.g., firewalls, anti-malware software, access controls, intrusion prevention systems, network anomaly detectors, email security, and the like, usually generate security alerts when triggered by anomalous or otherwise suspicious activity. Logs of such security alerts, often aggregated over the various tools, can be reviewed by network security analysts or administrators, who then assess whether a security threat is indeed present and take appropriate action. As the number of alerts can be far in excess of the amount that human network security administrators can handle—e.g., running into the tens or hundreds of thousands or even millions per day for a sizable organization—a network security solution may involve some form of clustering or grouping of the alerts, e.g., based on similarity between their attributes, into security incidents each deemed to correspond to a single cyberattack that affects many machines, users, applications, transactions, etc. In addition, human action on security incidents or alerts may be augmented with, or in some cases even obviated by, automated machine action taken to mitigate threats. Even with aggregation of alerts into far fewer incidents, however, the number of incidents (e.g., in the hundreds or thousands per day) may still consume substantial machine resources and/or be overwhelming to human analysts. In addition, the security incidents may include many false positives that unnecessarily trigger machine action and/or distract analysts from the true threats, rendering the network vulnerable to attacks.

### BRIEF DESCRIPTION OF DRAWINGS

FIG. 1 is a block diagram of an example network security system for monitoring and processing security incidents, in accordance with various embodiments.

FIG. 2 is a flow chart of an example method of processing security incidents based on similarity to previously encountered security incidents, in accordance with various embodiments.

FIG. 3A is a flow chart of an example method for finding similar security incidents using graph matching, in accordance with various embodiments.

FIG. 3B shows an algorithm for seeded graph matching as may be used in the method of FIG. 3A.

FIG. 4 is a flow chart of an example method for finding similar security incidents using incident “thumbprints” computed from graph embeddings, in accordance with various embodiments.

FIG. 5 is a block diagram of an example computing machine as may be used in implementing security incident monitoring and processing in accordance with various embodiments.

### DESCRIPTION

Described herein are systems and methods for leveraging knowledge about previous security incidents when processing a newly discovered incident, e.g., to reduce the analysis burden on human security analysts and/or improve the accuracy of security threat classification and suitability of any mitigating or other actions taken in response. In various embodiments, graph-based representations of security incidents are used to find, for a given security incident, other (e.g., prior) incidents that are similar in graph structure and/or attributes of the nodes and/or edges. The output generated for the incident at issue is then based at least in part on the identified similar incidents. For example, if the output includes a notification to a security analyst or other user associated with the computer network, the notification may include data for the identified similar security incident(s), thereby providing context for the user to assess the security incident at issue. Or, if the output includes an automatically selected mitigating action, the selection may mirror, or otherwise be based on, mitigating actions taken for the similar prior incident(s). It can also happen that the identified similar incident(s) turned out to be false positives; in this case, the security incident at issue may be deemed a false positive as well, and may therefore be suppressed.

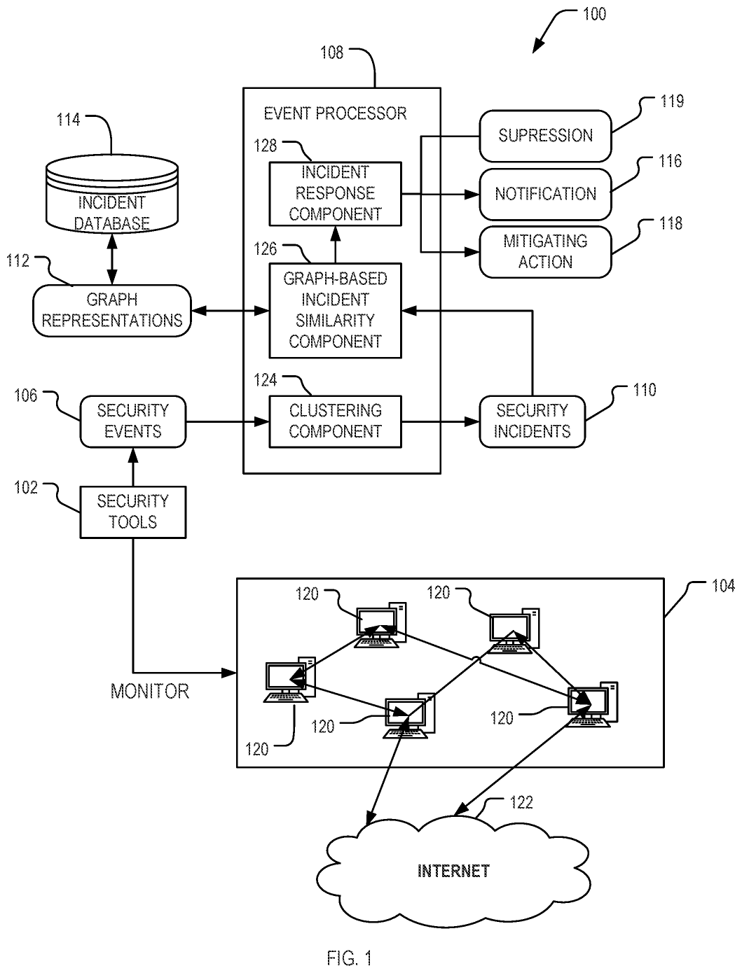

FIG. 1 is a block diagram of an example network security system 100 for monitoring and processing security incidents, in accordance with various embodiments. The system 100 includes one or more network security tools 102 that monitor the communications and activities within a computer network 104, and generate time-stamped records of security events 106. The term “security event” is herein used broadly for any observed event within the network (e.g., network communications, machine accesses by users or other machines, application launches, etc.) that is deemed relevant to assessing network security in the particular application, e.g., according to some defined set of security events or some applied definition. Security events generally include, but are not necessarily limited to, the kinds of unusual or suspicious observed network events that trigger security alerts within a production environment, or non-production alerts (also known as “traps”) within a test environment; these alerts constitute examples of security-event records in accordance herewith. In various embodiments, security events also include events that, even if they do not rise to the level of an immediate threat, are noteworthy to security analysts, such as telemetry events (triggered when certain observed network metrics reach specified values or thresholds) or anomalies in network behavior (whether benign or malicious).

The security events 106 and their associated attributes—such as, e.g., the event types or threat severity and the involved entities (machines, users, applications, files, etc.)—are processed in a computational component of the security system 100 herein termed the “event processor” 108. In accordance with various embodiments, event processing involves grouping events 106 that are “correlated,” e.g., by virtue of shared attribute values, into security incidents 110, and generating graph representations 112 of the security incidents 110, which may be stored in an incident database 114 of the security system 100. Each security incident 110 generally corresponds to a collection of security events 106 that are likely related to the same cyberattack and should therefore be treated collectively. Accordingly, the event processor 108 may output notifications 116 to security analysts or other users, and/or initiate threat-mitigating actions 118, that concern each security incident 110 as a whole. The graph representations 112 are used to identify, for a given security incident 110, similar incidents 110 that can provide contextual information to be included in the notifications 116 and/or can inform the selection of a suitable mitigating action 118, or cause suppression 119 of the incident 110 if it is determined to be a false positive.

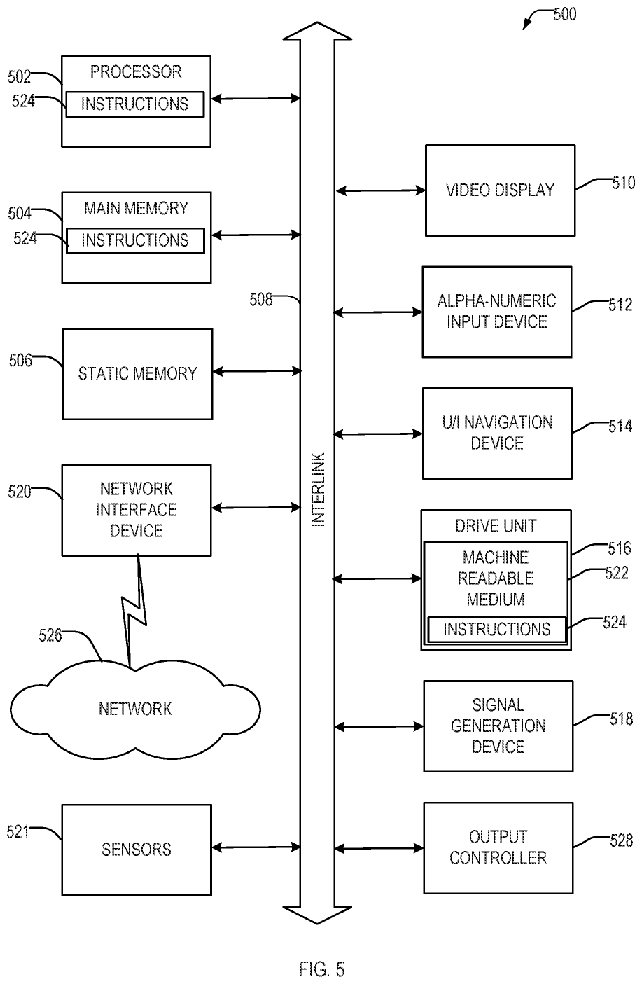

The computer network 104 includes multiple (e.g., often a large number of) computing machines 120, which can be accessed by users, store files, execute programs, and communicate with each other as well as with machines outside the organization via suitable wired or wireless network connections. In some embodiments, internal communications within the computer network 104 take place via a local area network (LAN) implemented, e.g., by Ethernet or Wi-Fi, or via a private wide area network (WAN) implemented, e.g.. via optical fiber or circuit-switched telephone lines. External communications may be facilitated via the Internet 122. The computing machines 120 within the computer network 104 may include; e.g., servers, desktop or laptop computers, mobile devices (e.g., smartphones, tablets, personal digital assistants (PDAs)), Internet-of-things devices, etc. The computer network 104 may be dynamic in that it includes, in addition to computing machines that are permanent parts of the computer network 104 (e.g., servers), also computing machines that are only temporarily connected to the computer network 104 at a given time (e.g., if a member of an organization, such as an employee of a company, accesses the intranet of the organization from outside the office via a personal device, such as a smartphone). The computing devices 120 may each include one or more (e.g., general-purpose) processors and associated memory; an example computing machine is described in more detail below with reference to FIG. 5.

To protect the computer network 104 from unauthorized access, data theft, malware attacks, or other cyberattacks, the network 104 is monitored, as noted above, by a number of network security tools 102, which may be implemented as software tools running on general-purpose computing hardware (e.g., any of the computing machines 120 within the computer network 104) and/or dedicated, special-purpose hardware security appliances. Non-limiting examples of security tools that may be utilized in the security system 100 include: one or more firewalls that monitor and control network traffic, e.g., via packet filtering according to predetermined rules, establishing a barrier between the computer network 104 and the Internet 122, and optionally between various sub-networks of the computer network 104; anti-malware software to detect and prevent and/or remove malware such as computer viruses, worms, Trojan horses, ransomware, spyware, etc.; intrusion detection and prevention systems that scan network traffic to identify and block attacks (e.g., by comparing network activity against known attack signatures); network anomaly detectors to spot malicious network behavior; authentication and authorization systems to identify users (e.g., by multi-factor authentication) and implement access controls; application security tools to find and fix vulnerabilities in software applications; email security tools to detect and block email-born threats like malware, phishing attempts, and spam; data loss prevention software to detect and prevent data breaches by monitoring sensitive data in storage; in network traffic, and in use; and/or endpoint protection systems, which employ a combination of measures to safeguard data and processes associated with the individual computing machines 120 serving as entry points into the computer network 104. These tools 102 generate security-event records, e.g., issue security alerts, responsive to detected security events 106. In some embodiments, comprehensive protection is provided by multiple security tools bundled into an integrated security suite. Sometimes, multiple such integrated security suites from different vendors are even used in combination for complementary protection. Security solutions may employ “security information and events management (SIEM)” to collect, analyze, and report security-event records across the different security products (e.g., different security tools or integrated security suites), e.g., to provide security analysts with aggregate information in a console view or other unified format. Further, to meet the growing complexity and sophistication of cyberattacks, a more recently developed approach that has come to be known in the art as “extended detection and response (XDR)” may perform intelligent automated analysis and correlation of security-event records across security layers (e.g., email, endpoint, server, cloud, network) to discern cyberattacks even in situations where they would be difficult to detect with individual security tools or SIEM. One nonlimiting example of an XDR product is Microsoft 365 Defender.

The event processor 108 may be implemented (e.g., as part of or in conjunction with an SIEM or XDR product) in software running on general-purpose computing hardware (e.g., any of the computing machines 120 within the computer network 104), optionally aided by hardware accelerators (e.g., graphic processing units (GPUs), field-programmable gate array (FPGA) or application-specific integrated circuit (ASIC)) configured for certain computationally expensive, but repetitive processing tasks. In accordance with various embodiments, the event processor 108 includes sub-components such as a clustering component 124, a graph-based incident similarity component 126, and an incident response component 128.

The clustering component 124 groups security events 106 that appear to relate to the same cyberattack into respective security incidents 110. For example, a malware attack may be carried out through a malicious email attachment sent to multiple users, and each such email may trigger a corresponding security alert, as may any user action to save or execute the attachment as well as various network activities that result from such execution; the individual security events underlying these alerts all belong to a single incident. As another example, a cyberattack generally proceeds through a sequence of stages in the “cyber kill chain,” which may include, for example: reconnaissance, initial access or infiltration, lateral movement through the network, and ultimately exfiltration (e.g., transfer of sensitive or otherwise valuable data to the attacker at a destination outside the network), weaponization and exploitation (e.g., the creation of a malware payload and triggering of the malware code once delivered), command and control (e.g., communications with the attacker outside the network that indirectly provide full control access within the network) and/or other means of data theft, data destruction, sabotage via viruses, or other harm. Along the kill chain, multiple different types of actions may take place and affect multiple machines, users, applications, data repositories, and so on. The clustering component 124 may aggregate security events 106 that triggered alerts at various stages of an attack into a single incident 110. In addition to cutting down on the number of items to be reviewed, clustering security events 106 into security incidents 110 provides humans (e.g., security analysts) and automated mitigation tools alike with a more holistic view of the attack, and thus the potential ability to respond more comprehensively and appropriately.

The clustering of security events 106 by the clustering component 124 may be accomplished in various ways. Events 106 may, for instance, be grouped together based on a set of heuristic rules that capture commonalities or patterns expected for the events 106 associated with a given attack, such as a common message text between multiple emails, or a certain sequence of actions carried out when a given item of malware is executed. Alternatively or additionally, the events 106 may be computationally represented as the nodes of a graph, with edges corresponding to shared attributes (e.g., the same affected machine or user) or similar relationships (e.g., a network communication that triggered both alerts) between any pair of nodes, and a clustering algorithm may then operate on the graph to identify clusters of events 106, where the clusters are generally characterized by higher connectivity between nodes within each cluster as compared to the connectivity between different clusters (or, in some embodiments, where a cluster contains all events 106 that are in some connected component of the graph). Security events 106 may be clustered in hatches (e.g., corresponding to certain time windows during which the events have been collected), or on an ongoing basis using continuous or periodic updates to an existing set of clusters, or with some combination of both. The clustering component 124 may also be or include one or more statistical models and/or machine-learning models, which may be trained and/or retrained, e.g., using feedback from a security analysts. Suitable clustering algorithms and machine-learning models (including methods of training them) are known to those of ordinary skill in the art.

The graph-based incident similarity component 126 further enhances the ability of security analysts and/or automated mitigation tools to select an appropriate response to an incident by supplying additional context. In accordance with various embodiments, the incident similarity component 126 generates a graph representation (herein also simply “graph”) 112 of each security incident 110, in which each security event 106 constitutes a node. (As will be appreciated by those of ordinary skill in the art, that graph structure may also be used in the preceding event clustering step to generate the instances in the first place. As such, the clustering component 124 and graph-based incident similarity component 126 may share some functionality.) The graph representation 112 of the incident also encodes, in some way, attributes of the security events 106. In some embodiments, one or more of the attributes of the security events 106 are treated as node attributes. In this manner, nodes that share the same value for a given attribute form a distinct class of nodes. For example, the nodes within the graph may fall into different classes based on event titles associated with the nodes; the nodes may be said to be “colored” by the event titles. In some embodiments, one or more of the attributes are incorporated into the graph as separate nodes. For example, entities associated with the security events 106, such as machines, users, application programs, etc. involved in the underlying security events may be represented as nodes in their own right.

Depending on the types of nodes present in the graph, edges may be formed in different ways. In graphs that include only security-event nodes, edges may be created between pairs of nodes that are correlated in terms of their attributes, e.g., such that two security events involving the same machine are connected. In graphs that include nodes for security events as well as entities (and/or other types of nodes), edges may be formed between pairs of nodes of two different types. For example, nodes representing security events may be connected to nodes representing the respective involved entities (e.g., machine and user), nodes representing users may be connected to nodes representing the respective machines accessed by the users, nodes representing machines may be connected to nodes representing the respective application programs they execute, etc. In some embodiments, the edges are limited to pairs of nodes of two different types, resulting in multipartite graphs. In other embodiments, edges between nodes of the same type, such as between two machines or between two alerts, are also possible. The edges, like the nodes, may have attributes in some embodiments. For example, an edge between two security events 106 may be “colored” by the type of correlation between them, such that an edge formed based on a common involved machine would have a different attribute than an edge formed based on a common network communication that triggered both alerts.

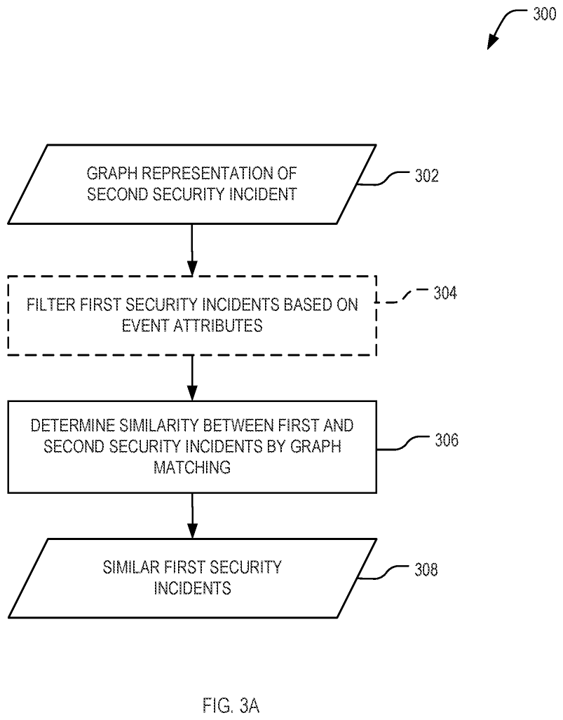

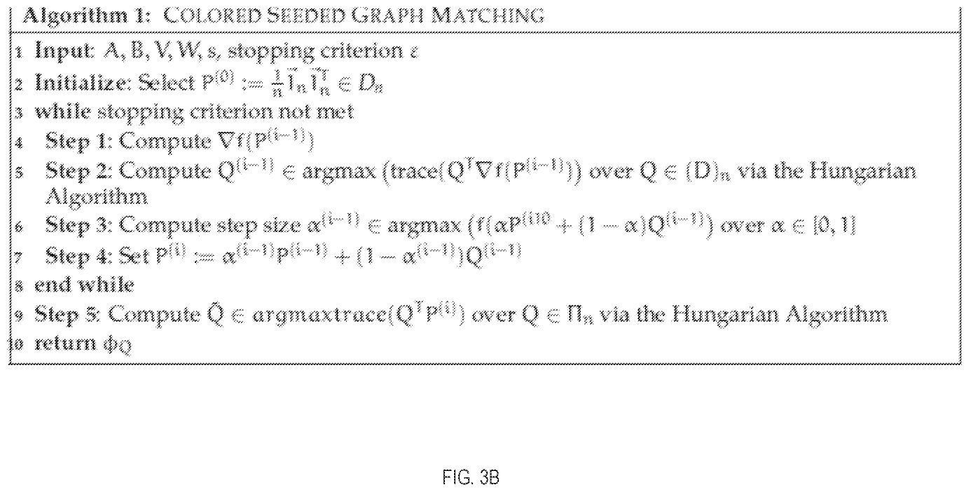

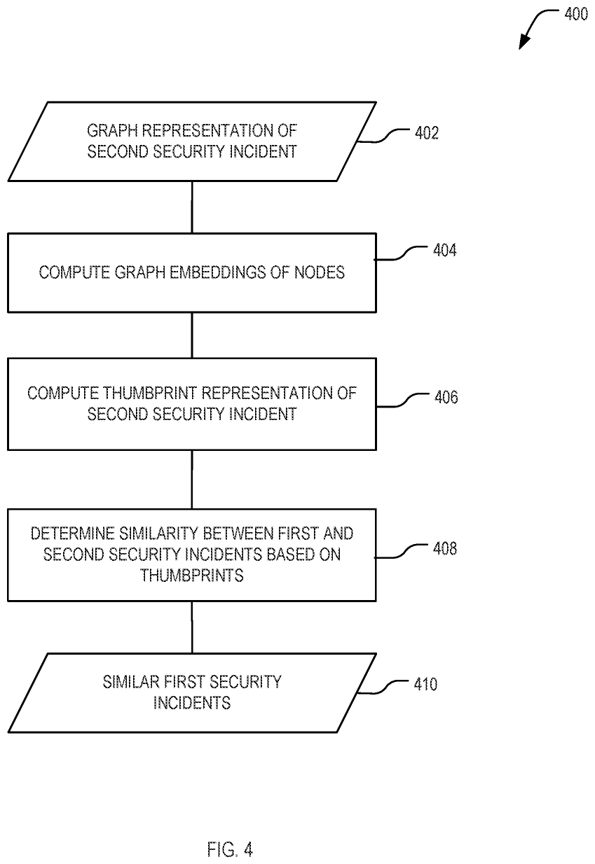

The graphs representations 112 for the security incidents 110, optionally along with other data about the incidents 110, may be stored in an incident database 114, forming a library for subsequent look-up. For a given security incident 110 output by the clustering component 124, the graph-based incident similarity component 126 can then compare a graph representation 112 of that incident against the graph representations 112 stored in the incident database 114 to identify one or more stored incidents that are similar in graph structure (that is, the pattern of edges between nodes) and/or attributes of the nodes and/or edges (hereinafter both encompassed in the term “graph attributes”). Graph similarity may be determined in various ways, such as using graph matching techniques (as described in detail below with reference to FIG. 3) or graph thumbprints created from node-level graph embeddings (as described below with reference to FIG. 4). To account for the security-event attributes in determining graph similarity, in various embodiments, the graph attributes representing security-event attributes are used to filter incidents prior to or after identifying similar graph structures; similarity in graph attributes (representing security-event attributes) and in graph structure are determined in an integral manner; and/or the graph structure itself reflects the security-event attributes (e.g., as separate nodes), and similarity in graph structure, consequently, reflects in part similarity in security-event attributes. The similarity of each incident 110 to the incident 110 at issue may be scored, and the similarity scores may be returned along with a number of highest-ranking similar incidents.

The incidence response component 128 generates, upon detection of a security incident 110, a suitable output, such as a notification 116 to a security analyst, who may then initiate a mitigating action 118, or the automated initiation of a mitigating action 118. Notifications 116 may, for example, presented in a user interface, e.g., taking the form of an interactive console, that provides an ordered list of security incidents 110 for review by a user (e.g., a security analyst or network administrator), and allows the user to select individual incidents 110 for a more in-depth examination of the constituent security events 106 and associated attributes and other related data. Alternatively or additionally, notifications 116 of high-priority incidents 110, as evaluated by some suitable prioritization metric, may be sent to the user via email, text, or in some other form. Mitigating actions 118, whether taken automatically or initiated by a security analyst or administrator, may include, for example and without limitation: suspending network accounts, requiring that users reset their passwords, isolating affected machines, performing scans for viruses and other malware, de-installing identified malware, sending warnings (e.g., about phishing attacks or email attachments containing malware) to network users, backing up valuable information, increasing the level of network traffic monitoring, etc.

In accordance with various embodiments, the output generated by the incident response component 128 is informed by one or more security incidents 110 determined to be similar to the incident 110 at issue. For example, any notification 116 may include data not only for the incident 110 at issue, but also data for the similar incident(s) 110 returned by the incident similarity component 126. Such data may include, e.g., any determination of threat actors or threat campaigns responsible for the similar incidents 110, actions 118 taken in response to the similar incidents 110, etc. In some cases, the incident response component 128 may dismiss a security incident 110 as a false positive on the ground that identified similar incidents 110 turned out to be false positives; in other words, the action taken by the incidence response component 128 may be suppression 119 of the incident 110.

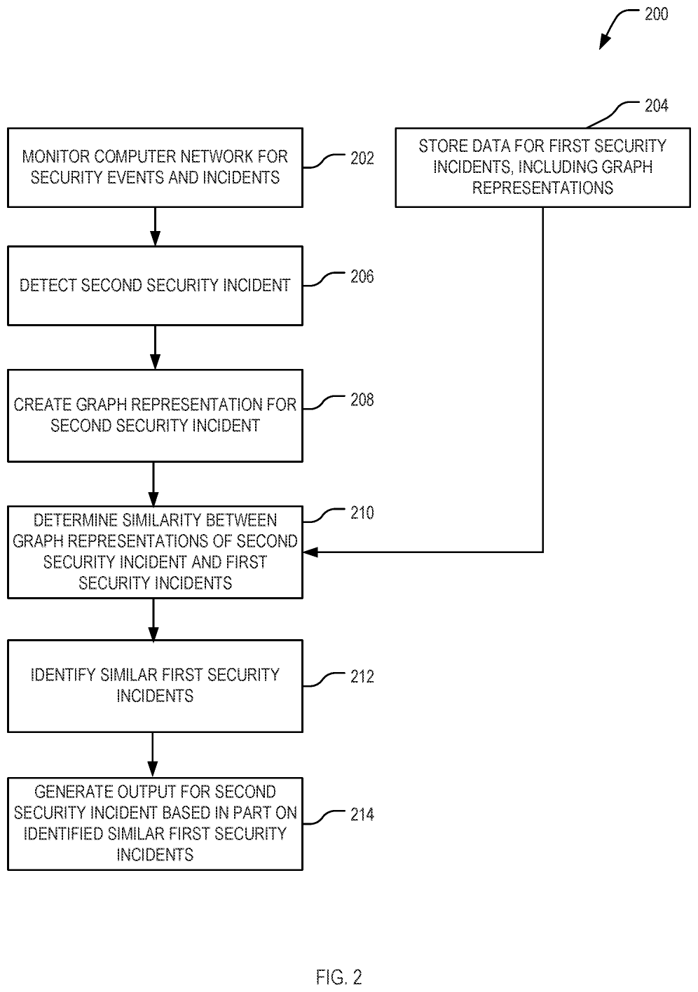

FIG. 2 is a flow chart of an example method 200 of processing security incidents based on similarity to previously encountered security incidents, in accordance with various embodiments. The method 200, which may be carried out with a network security system 100 as described above, involves monitoring a computer network 104 for security events 106 and groups of correlated security events that collectively form a security incident 110 (act 202), and storing data (generally including graph representations 112) for the security incidents 110, e.g., in an incident database 114 (act 204). The stored security incidents are hereinafter also referred to as “first (security) incidents,” to distinguish from a given security incident to be processed, which is hereinafter also referred to as the “second (security) incident.” Upon detection, among the monitored security events, of a group of correlated security events that constitute a second security incident (in act 206), a graph representation is created for that second security incident (act 208). The graph representation includes nodes representing the security events within the incident, and optionally associated entities or other attributes of the security events.

Alternatively or additionally to encoding the attributes of the security events as separate nodes, the graph representation may encode them as graph attributes.

In act 210, the graph representation of the second security incident is compared, in graph structure and/or graph attributes, and in a manner that takes attributes of the security events into account, against the stored security incidents to determine degrees of similarity, e.g., in the form of quantitative similarity scores (act 210). With attributes of the security events being encoded in the graph structure (as separate nodes), graph attributes, or both, this comparison inherently takes the attributes of the security events into account. Based on the determined similarity, one or more incidents that are similar to the second security incident are identified among the first security incidents (act 212). An output, such as a notification 116 to a user or automated mitigating action 118 is then generated based in part on the identified similar first security incidents (act 214). A notification 116 may, for instance, include contextual data derived from or pertaining to the identified similar security incident(s), such as a targeted attack notification associated with the similar security incident(s). A mitigating action 118 may be selected based on one or more mitigating actions associated with the similar security incident(s). In many applications, the first security incidents will precede the second security incident in time; that is, processing of a given security incident will be based in part on similar prior incidents. In principle, however, unless security incidents are processed in real time, it is also possible that processing of a second incident is informed by similar incidents in its future.

In generating an output based on multiple similar incidents, the similarity scores may be taken into account. For example, if the mitigating actions taken in response to the identified similar first security incidents differ, an automated action taken for the second security incident may be based on the action taken for the highest-scoring, most similar first security incident. Alternatively, the selected action for the second security incident may depend on the mitigating action taken most often among the similar fist security incidents. In a notification to a user, data about all first incidents whose similarity to the second incident exceeds a certain threshold may be included, providing the security analyst with contextual information from which inferences about the second security incident may be drawn; similarity scores may be included to allow the analyst to properly assess the relevance and relative weights of the reported first security incidents.

FIG. 3 is a flow chart of an example method 300 for finding similar security incidents using graph matching, in accordance with various embodiments. The method 300 takes a graph representation of a (second) security incident, as generated in act 208 of method 200, as input at 302. The nodes of this graph representation correspond to security events within the incident, and may have node attributes reflecting entities and other metadata associated with the security events. Optionally, in act 304, the (first) security incidents are filtered based on the event attributes to select a subset of incidents for further comparison. For example, in some embodiments, act 304 returns a set of first security incidents that overlap substantially with the second security incident in event titles (as may be reflected in the titles of the security-event records, such as alert titles of security alerts triggered by the events) and/or entities (e.g., machines or users) associated with the events. In one particular embodiment, the filtering is based on rare event titles, where rarity of an event title is measured in terms of the fraction, or percentage, of events within a dataset (e.g., the set of all events recorded within a specified period of time, such as the last 28 days) that have that specific event title. To illustrate, an event title may occur, for instance, only tens of times within a pool of tens of thousands of security-event records, while more common event titles may be associated with hundreds or thousands of events within the pool. Based on the notion that the attack pattern, or character, of an incident is determined largely by the rare types of security events (with types of events being reflected in the events titles), the filtering act 304 may retrieve, for a second security incident with a security-event node having a rare title, first security incidents that share that same rare event title.

The method 300 further involves determining the similarity between the second security incident and each of a set of first security incidents, such as, e.g., the first incidents that have passed the filtering in act 304, by graph matching (act 306). Graph matching attempts to map each node of one graph to a corresponding node of the other graph in a manner that preserves the graph structure, meaning the edges connecting the nodes, between the two graphs—or in inexact graph matching, minimizes the discrepancies between the edges in the two graphs. Thought of in terms of the adjacency matrices of the graphs, graph matching amounts to permuting the rows and columns of one adjacency matrix so as to match the other adjacency matrix. As will be readily appreciated by those of skill in the art, graph matching between two graphs that differ in the number of nodes or edges is necessarily inexact (although it does not exclude the possibility of an exact match between the smaller graph with a subgraph of the larger graph). For inexactly matched graphs, the dissimilarity between them can be quantified in terms of the number pairs of nodes that are connected by an edge in one of the graphs, but not the other.

Various graph matching techniques suitable to determine the similarity between the graph representations of the first and second security incidents in act 304 are known to those of ordinary skill in the art. For example, some embodiments employ seeded graph matching, as described by Fishkind et al. in an article entitled “Seeded Graph Matching” (published as arXiv:1209.0367). Seeded graph matching between two graphs G₁ and G₂ each having n nodes (where, if one of the graphs has initially fewer nodes than the other, the smaller graph can be augmented with unconnected nodes for both graphs to be represented by the same number of nodes n) starts from a fixed mapping between a subset of nodes of graph G₁ and a subset of nodes of graph G₂ (the mapping constituting the “seed”) and solves an optimization problem that can be formally stated as:

min_{P∈Π}_{ₙ}∥A−(Iₘ⊕P)B(Iₘ⊕P)^{T}∥_{F}²,

where A and B are the n×n adjacency matrices of G₁ and G₂, respectively, Πₙ is the set of n×n permutation matrices, m is the number of nodes in the seed, Iₘ is the m×m identity matrix, ⊕ is the direct sum of matrices, and ∥ ∥_{F} is the Frobenius norm on matrices. The problem can be solved in an approximate manner by relaxing the permutations to P∈Dₙ, the doubly stochastic matrices, and then iteratively optimizing the objective function:

ƒ(P)=2(trace(A₂₁B₂₁)+trace(P^{T}A₂₁B₂₁^{T})+trace(P^{T}A₂₁^{T}B₁₂)+trace(A₂₂^{T}PB₂₂P^{T})).

FIG. 3B shows an algorithm for seeded graph matching as may be used in the method 300 to perform this optimization.

In some embodiments, graph matching is enhanced to attempt matching not only graph structure, but also graph attributes. Simultaneously matching structure and attributes can be achieved by adding a term to the optimization problem that captures the discrepancy in attribute values between the two graphs. Considering a single attribute to be matched, the attribute values for the nodes in each graph can be captured in vectors v, w for the two graphs G₁ and G₂, respectively. Alternatively, for any given attribute value c, 0,1-indicator vectors v_{c}, w_{c} may be used to reflect for each node whether it has that attribute value c, and for k possible attribute values, k such indicator vectors may be assembled into k×n attribute matrices V, W for the two graphs G₁ and G₂. The optimization problem can then be augmented to:

min_{P∈Π}_{ₙ}∥A−(Iₘ⊕P)B(Iₘ⊕P)^{T}∥_{F}²+∥V−(Iₘ⊕P)W∥_{F}².

The corresponding objective function to be optimized (e.g., using the algorithm of FIG. 3B) then becomes:

ƒ(P)=2(trace(A₂₁B₂₁)+trace(P^{T}A₂₁B₂₁^{T})+trace(P^{T}A₁₂^{T}B₁₂)+trace(A₂₂^{T}PB₂₂P^{T}))+∥V₂−PW₂∥_{F}².

This objective function is indicative of the similarity between the two graphs G₁ and G₂ in both graph structure and node attributes. As will be readily appreciated by those of ordinary skill in the art, a similar extension to the objective function can be used to account for similarity in edge attributes.

With renewed reference to FIG. 3A, graph matching in act 306 determines the best possible alignment between the graphs representations of the second security incident and each of the considered first security incidents, and returns a similarity score for each pair of first and second incidents. The similarity scores may, for example, be based on the value of the objective function, or may be a count of the number of pairs of matched nodes in the two graph structures that also match in the considered node attribute (e.g., alert title). Based on the similarity scores, one or more first incidents that are similar to the second incident are then provided as the output 308. First incidents may be deemed similar if their associated similarity scores exceed (or, equivalently, dissimilarity scores fall below) a specified threshold. Alternatively, the first incidents may be ranked by similarity, and a set number of the highest-ranking (most similar) incidents may be returned as output 308.

FIG. 4 is a flow chart of an example method 400 for finding similar security incidents using incident “thumbprints” computed from graph embeddings, in accordance with various embodiments. The method 400 (like method 300) takes a graph representation of a (second) security incident, as generated in act 208 of method 200, as input at 402. This graph representation includes nodes representing security alerts within the incident, and in some embodiments also nodes representing entities, user annotations, and/or other attributes associated with the security events. Further, the graph may include nodes representing insights associated with multiple security events as a group or with the incident as a whole, such as the initial starting point (or “seed”) of the incident (not to be confused with the seed used in seeded graph matching as described above) and/or weightings that capture the relative importance or interest associated with different security events. In addition, relationships between the events, entities, or other categories represented by a pair of nodes can be encoded with additional nodes inserted therebetween.

Alternatively or additionally to using nodes representing event attributes, insights, or relationships between nodes, the graph representation may encode such information as graph attributes (e.g., with node attributes reflecting the attributes of the security events, and/or edge attributes representing relationships between events). For graphs including different types of nodes, each node type may have its own set of attributes. Further, the nodes in the graph representation may have associated attribute vectors that encode metadata associated with respective security events, entities, or other represented types. The graph attributes of the nodes may be captured in attribute vectors of a common fixed length. To accommodate nodes of different types, each with its own associated set of attributes, the attribute vectors may be a concatenation of attribute vectors of the individual node types, with values for any attributes not applicable to a given node being set to zero. For example, in a graph including event nodes and entity nodes, attributed by attribute vectors including eight event attributes and ten entity attributes, the last ten attribute values of each event node and the first eight attribute values of each entity node would be zero.

In act 404, graph embeddings of the nodes (or “node embeddings”) are computed from the graph of the security incident with a suitable embedding model, e.g., corresponding to the encoder within the encoder-decoder framework of a graph representational learning technique. The embedding model maps the nodes onto fixed-length vector representations, which are typically low-dimensional as compared with the attribute vectors of the nodes. The embedding model may be configured, e.g., as a result of model training, to preserve neighborhood similarity, meaning that two nodes whose local neighborhoods are similar in graph structure and attributes map onto embeddings whose mutual distance is small, or equivalently, whose similarity is high (as measured by some suitable distance or similarity metric, such as the Cartesian distance between the embedding vectors in the embedding space or the cosine similarity between the embedding vectors). Various graph representational learning approaches that may be employed to generate the node embeddings are known to those of ordinary skill in the art, and include, e.g., factorization-based approaches (e.g., Laplacian eigenmaps and inner-product methods), random walk embedding methods (e.g., DeepWalk and node2vec, large-scale information network embeddings (LINE)), graph neural networks (GNNs), and neighborhood aggregation and convolutional encoders like graph convolutional networks (GCNs) and the GraphSAGE (SAmple and aggreGatE) algorithm.

In some embodiments, GraphSAGE (e.g., heterogeneous GraphSAGE) is used to generate the node embeddings. GraphSAGE iteratively aggregates attribute vectors of nodes within the local neighborhood of a given node into a graph embedding for that node, and is as such particularly suited for use with graph representations that encode security metadata at least in part in node attributes. (Note that GraphSAGE can, in principle, also be applied to graphs without node attributes, using instead features implicit in the graph structure, such as node degrees.) In brief, GraphSAGE initializes node representations based on the attribute vectors of the nodes, and then iteratively updates the node representations by aggregating, for each node, the node representations of its immediate neighbors into a neighborhood vector (using a suitable aggregation function), combining (e.g., concatenating) the neighborhood vector with the current node representation of the node at issue, and passing the combined vector through a dense neural network layer (e.g., represented by a weight matrix associated with the iteration) to compute the updated node representation. Over successive iterations, the node representations incorporate information from increasingly farther neighbor nodes. The updated representation after a specified number of iterations, also called the “depth” of the embedding, is returned as the final node embedding. The depth corresponds to the number of degrees of separation across which nodes affect the embeddings of their neighbors. More detail about GraphSAGE can be found, e.g., in “Inductive Representation Learning on Large Graphs” by W. Hamilton, R. Ying, and J. Lesokovect, published as arXiv:1706.02216.v4 (2018).

From the graph embeddings of the individual nodes, a “thumbprint” representation (herein also referred to as “thumbprint” for short) of the incident as a whole is created in act 406. Since the graph from which the embeddings are computed encodes attributes of the security events in the graph structure (as separate nodes), as graph attributes, or both, the thumbprint created from the embeddings likewise encodes the event attributes (along with the graph structure). In some embodiments, the thumbprint representation is simply the sum or average of the node embeddings. In other embodiments, the nodes within the graph are clustered based on the embeddings, the number of nodes within each cluster is counted, and the counts for all clusters are then assembled into a vector that constitutes the thumbprint of the incident. The clustering may be performed with any of a number of suitable clustering techniques known to those of skill in the art, for instance using k-means clustering. In brief, k-means clustering algorithms aim at partitioning n nodes into k clusters in a way such that each node belongs to the cluster with the nearest cluster center, the cluster center being the mean of the positions of all node embeddings within the embedding space. Such clustering can be achieved, e.g., by a process of iterative refinement, where, starting from arbitrary initial cluster centers, in each iteration, nodes are assigned to the closest cluster, and the mean of node positions within the cluster is then updated based on the node assignments. In some embodiments, the node embeddings associated with the incident are clustered multiple times for different respective values of k (corresponding to different numbers of clusters), and the counts for each clustering are concatenated to form the thumbprint representation 158. For example, if clustering is performed for values of k=5, 10, and 20, the resulting thumbprint would be a 35-component vector containing the node counts of the clusters for all three clusterings.

Finally, the thumbprint of the second security incident can be compared with thumbprints previously computed, in the same manner, for the first security incidents, to determine the distances (dissimilarity), or similarity, between pairs of first and second nodes (act 408). Any suitable metric for scoring the distance or similarity between two vectors (e.g., the cosine similarity or Cartesian distance within the thumbprint space) may be used for this purpose. Based on the similarity (or distance) scores, one or more first incidents that are similar to the second incident (e.g., any first incident that exceeds a similarity threshold, or a set number of highest-ranking first incidents) are then provided as the output 410.

The methods 300, 400 provide two different technical means for determining similarity between security incidents in a manner that takes the attributes of the security events into account. Additional embodiments may combine features from both methods 300, 400. For example, regardless whether the thumbprint method 400 does or does not inherently encode alert attributes in the node embeddings and incident thumbprints, the computation of thumbprints may be preceded, or followed, by a filtering step that is based on node attributes, as described in the context of the graph-matching method 300. In any case, the effect of determining similar incidents, especially when similarity is based in part on alert attributes, is to provide rich information and context that supports the further processing of security incidents, facilitating automation of mitigating actions in some embodiments, and—regardless whether further processing is conducted manually by humans or automatically by machines—enabling more accurate threat assessments and better targeted and more appropriate mitigating actions in many cases.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a smartphone, a web appliance, a network router, switch or bridge, a server computer, a database, conference room equipment, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service SaaS), other computer cluster configurations.

In various embodiments, machine(s) 500 may perform one or more of the processes described above with respect to FIGS. 3A-3B and 4 above. example, within the system 100 of FIG. 1, one or more machines 500 may implement any of computing machines 120, any of the security tools 102 for generating security events, and/or any of the components 124, 126, 128 of the event processor 108 for processing the security events.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 516 may include a machine-readable medium 522 on which are stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine-readable media.

While the machine-readable medium 522 is illustrated as a single medium, the term “machine-readable medium” may include a single medium or multiple media (e.g., a centralized or distributed database, and/or associated caches and servers) configured to store the one or more instructions 524.

The term “machine-readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine readable media. In some examples, machine-readable media may include machine-readable media that are not a transitory propagating signal.

The instructions 524 may further be transmitted or received over a communications network 526 using a transmission medium via the network interface device 520. The machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The following numbered examples are illustrative embodiments.

Example 1 is a computer-implemented method that includes storing data for a plurality of first security incidents each comprising multiple first security events; monitoring a computer network for second security events; detecting, among the second security events, a group of correlated second security events collectively constituting a second security incident; and processing the second security incident based in part on the stored data for the first security incidents. The processing includes generating a graph representation of the second security incident. The graph representation includes nodes representing the second security events within the group of correlated second security events, and encodes attributes of the second security events. The processing further includes determining similarity between the graph representation of the second security incident and graph representations of at least some of the first security incidents. Those graph representations of the first security incidents include nodes representing the first security events, and encode attributes of the first security events. The processing further involves identifying, among the first security incidents, one or more incidents whose graph representations are similar to the graph representation of the second security incident, and generating an output for the second security incident based on the identified one or more similar first security incidents.

Example 2 is the method of example 1, wherein the one or more identified similar first security incidents are scored according to similarity, and the output is based on the scoring.

Example 3 is the method of example 1 or example 2, wherein the output includes a notification to a user associated with the computer network. The notification includes data for the identified one or more similar first security incidents.

Example 4 is the method of example 3, where the data for the identified one or more similar first security incidents includes a targeted attack notification associated with one of the similar first security incidents.

Example 5 is the method of any of examples 1-4, wherein the output includes an automated action taken on the second security incident based on one or more actions associated with the identified one or more similar first security incidents.

Example 6 is the method of example 5, wherein the automated action(s) include a threat-mitigating action.

Example 7 is the method of example 5, wherein the action(s) associated with the one or more identified similar first security incidents include a determination that the identified similar first security incident(s) was (or were) a false positive (false positives), and wherein the automated action taken on the second security incident involves suppressing the second security incident.

Example 8 is the method of any of examples 1-6, wherein the plurality of first security incidents include security incidents representative of attack patterns of known threat actors

Example 9 is the method of any of examples 1-8, wherein the attributes of at least some of the first and second security events are encoded as node attributes in the graph representations of the respective first and second security incidents, and wherein the similarity determined between the graph representation of the second security incident and the graph representations of at least some of the first security incidents comprises similarity in graph structure and node attributes.

Example 10 is the method of example 9, wherein determining the similarity in graph structure and node attributes between the graph representation of the second security incident and graph representations of at least some of the first security incidents involves using a graph matching algorithm to iteratively optimize an objective function indicative of the similarity in at least graph structure.

Example 11 is the method of example 10, wherein determining the similarity in graph structure and node attributes further comprises, prior to using the graph matching algorithm, filtering the first security incidents based on the node attributes.

Example 12 is the method of example 11, wherein the node attributes comprise event titles, and wherein one or more second security events that have a rare associated event title are determined. Similarity is then determined between the graph representation of the second security incident and first security incidents that each include at least one first security event also having that rare event title.

Example 13 is the method of any of examples 1-12, wherein the attributes of at least some of the first and second security events are encoded as additional nodes in the graph representations of the respective first and second security incidents.

Example 14 is the method of any of examples 1-13, wherein determining the similarity between the graph representation of the second security incident and graph representations of at least some of the first security incidents includes computing graph embeddings of the nodes of the graph representation of the second security incident, computing a thumbprint representation of the second security incident from the graph embeddings, and computing distances between the thumbprint representation of the second security incident and thumbprint representations of the first security incidents, those thumbprint representations having been computed from the graph representations of the respective first security incidents.

Example 15 is the method of example 14, wherein computing the thumbprint representation comprises clustering the nodes in the graph representation based on their graph embeddings and counting the nodes within each cluster.

Example 16 is the method of any of examples 1-15, wherein the attributes of the first and second security events comprise entities within the computer network.

Example 17 is a computer system including one or more hardware processors and one or more machine-readable media. The machine-readable media store data for a plurality of first security incidents each comprising multiple first security events, and instructions that, when executed by the one or more hardware processors, cause the one or more hardware processors to perform operations for processing a second security incident comprising multiple second security events based in part on the stored data. The operations include generating a graph representation of the second security incident, where the graph representation includes nodes representing the second security events and encodes attributes of the second security events. Further, the operations include determining similarity between the graph representation of the second security incident and graph representations of at least some of the first security incidents, where the graph representations of the first security incidents include nodes representing the first security events and encode attributes of the first security events. Moreover, the operations involve identifying one or more incidents among the first security incidents whose graph representations are similar to the graph representation of the second security incident, and generating an output for the second security incident based on the identified one or more similar first security incidents.

Example 18 is the system of example 17, wherein the second security events of the second security incident are a group of correlated second security events detected among security events occurring within a monitored computer network.

Example 19 is the system of example 17 or example 18, wherein the output includes at least one of a notification to a user that includes data for the identified one or more similar first security incidents, or an automated action taken on the second security incident based on an action associated with the identified one or more similar first security incidents.

Example 20 is the system of any of examples 17-19, configured to implement the method of any of examples 1-16.

Example 21 is a non-transitory machine-readable medium, or set of multiple non-transitory machine-readable media, that stores or store data for a plurality of first security incidents each comprising multiple first security events; and instructions that, when executed by one or more hardware processors, cause the one or more hardware processors to perform operations for processing a second security incident comprising multiple second security events based at least in part on the stored data. The operations include generating a graph representation of the second security incident, where the graph representation includes nodes representing the second security events and encodes attributes of the second security events. Further, the operations include determining similarity between the graph representation of the second security incident and graph representations of at least some of the first security incidents, where the graph representations of the first security incidents include nodes representing the first security events and encode attributes of the first security events. Moreover, the operations involve identifying one or more incidents among the first security incidents whose graph representations are similar to the graph representation of the second security incident, and generating an output for the second security incident based on the identified one or more similar first security incidents.

Example 22 is the non-transitory machine-readable medium or set of multiple non-transitory machine-readable media of examples 21, with operations to implement the method of any of examples 1-16.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings, which form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

What is claimed is:

1. A computer-implemented method comprising:
storing data for a plurality of first security incidents each comprising multiple first security events;
monitoring a computer network for second security events;
detecting, among the second security events, a group of correlated second security events collectively constituting a second security incident;
generating a graph representation of the second security incident, the graph representation comprising nodes representing the second security events of the group and encoding attributes of the second security events;
determining similarity between the graph representation of the second security incident and graph representations of at least some of the first security incidents, the graph representations of the first security incidents comprising nodes representing the first security events and encoding attributes of the first security events;
identifying at least one incident among the first security incidents whose graph representation is similar to the graph representation of the second security incident; and
generating an output for the second security incident based on the at least one identified similar first security incident.

2. The method of claim 1, further comprising scoring the at least one identified similar first security incident according to similarity, wherein the output is based on the scoring.

3. The method of claim 1, wherein the output comprises a notification to a user associated with the computer network, the notification including data for the at least one identified similar first security incident.

4. The method of claim 4, wherein the data for the at least one identified similar first security incident comprises a targeted attack notification associated with the at least one identified similar first security incident.

5. The method of claim 1, wherein the output comprises an automated action taken on the second security incident based on an action associated with the at least one identified similar first security incident.

6. The method of claim 5, wherein the automated action comprises a threat-mitigating action.

7. The method of claim 5, wherein the action associated with the at least one identified similar first security incident comprises a determination that the at least one identified similar first security incident was a false positive, and wherein the automated action taken on the second security incident comprises suppressing the second security incident.

8. The method of claim 1, wherein the plurality of first security incidents comprises security incidents representative of attack patterns of known threat actors.

9. The method of claim 1, wherein the attributes of at least some of the first and second security events are encoded as node attributes in the graph representations of the respective first and second security incidents, and wherein the similarity determined between the graph representation of the second security incident and the graph representations of the at least some of the first security incidents comprises similarity in graph structure and node attributes.

10. The method of claim 9, wherein determining the similarity in graph structure and node attributes between the graph representation of the second security incident and graph representations of at least some of the first security incidents comprises using a graph matching algorithm to iteratively optimize an objective function indicative of the similarity in at least graph structure.

11. The method of claim 10, wherein determining the similarity in graph structure and node attributes further comprises, prior to using the graph matching algorithm, filtering the first security incidents based on the node attributes.

12. The method of claim 11, wherein the node attributes comprise event titles, the method further comprising determining at least one second security events having a rare associated event title, wherein the at least some of the first security incidents are security incidents that each include at least one first security event having the rare event title.

13. The method of claim 1, wherein the attributes of at least some of the first and second security events are encoded as additional nodes in the graph representations of the respective first and second security incidents.

14. The method of claim 1, wherein determining the similarity between the graph representation of the second security incident and graph representations of the at least some of the first security incident comprises computing graph embeddings of the nodes of the graph representation of the second security incident, computing a thumbprint representation of the second security incident from the graph embeddings, and computing distances between the thumbprint representation of the second security incident and thumbprint representations of the at least some of the first security incidents computed from the graph representations of the at least some of the first security incidents.

15. The method of claim 14, wherein computing the thumbprint representation comprises clustering the nodes in the graph representation based on their graph embeddings and counting the nodes within each cluster.

16. The method of claim 1, wherein the attributes of the first and second security events comprise entities within the computer network.

17. A computer system, comprising:
one or more hardware processors; and
one or more machine-readable media storing:
data for a plurality of first security incidents each comprising multiple first security events; and
instructions that, when executed by the one or more hardware processors, cause the one or more hardware processors to perform operations for processing a second security incident comprising multiple second security events, the operations comprising:
generating a graph representation of the second security incident, the graph representation comprising nodes representing the second security events and encoding attributes of the second security events;
determining similarity between the graph representation of the second security incident and graph representations of at least some of the first security incidents, the graph representations of the first security incidents comprising nodes representing the first security events and encoding attributes of the first security events;
identifying at least one incident among the first security incidents whose graph representation is similar to the graph representation of the second security incident; and
generating an output for the second security incident based on the at least one identified similar first security incident.

18. The system of claim 17, wherein the second security events of the second security incident are a group of correlated second security events detected among security events occurring within a monitored computer network.

19. The system of claim 17, wherein the output comprises at least one of a notification to a user that includes data for the at least one identified similar first security incident, or an automated action taken on the second security incident based on an action associated with the at least one identified similar first security incident.

20. One or more non-transitory machine-readable media storing:
data for a plurality of first security incidents each comprising multiple first security events; and
instructions that, when executed by one or more hardware processors, cause the one or more hardware processors to perform operations for processing a second security incident comprising multiple second security events, the operations comprising:
generating a graph representation of the second security incident, the graph representation comprising nodes representing the second security events and encoding attributes of the second security events;
determining similarity between the graph representation of the second security incident and graph representations of at least some of the first security incidents, the graph representations of the first security incidents comprising nodes representing the first security events and encoding attributes of the first security events;
identifying at least one incident among the first security incidents whose graph representation is similar to the graph representation of the second security incident; and
generating an output for the second security incident based on the at least one identified similar first security incident.
